(19) United States
(12) Patent Application Publication
(10) Pub. No.: US 2024/0120134 A1
(43) Pub. Date: Apr. 11, 2024

(54) GROMMET

(71) Applicant: SUMITOMO WIRING SYSTEMS, LTD., Mie (JP)

(72) Inventor: Taiki KOBAYASHI, Mie (JP)

(21) Appl. No.: 18/273,480

(22) PCT Filed: Feb. 4, 2022
(86) PCT No.: PCT/JP2022/004450

§ 371 Date: Jul. 20, 2023

(30) Foreign Application Priority Data
Feb. 8, 2021 (JP) 2021-018333

(51) Int. Cl. H01B 17/58; F16L 5/10; H02G 3/22

(52) U.S. Cl. CPC H01B 17/583; F16L 5/10; H02G 3/22; B60R 16/0222

(57) ABSTRACT

A grommet is provided with a first tubular portion through which an electrical wire can be inserted, a collar portion, and a first fold portion. The grommet is deformable between a first state in which the first fold portion is contracted in a folded state and a second state in which at least a portion of the first fold portion is extended. In the first state, an angle formed by an axis line of the first tubular portion and a virtual plane corresponds to a first angle, and, in the second state, an angle formed by an axis line of the first tubular portion and the virtual plane corresponds to a second angle, which is smaller than first angle. A distal end opening of the first tubular portion is orientated to a first side in a second direction aligned with the virtual plane.

### TECHNICAL FIELD

The present disclosure relates to a grommet.

### BACKGROUND

The grommet described in Patent Document 1 is used in a wire harness. The grommet includes a tubular portion through which electrical wire is inserted and a collar portion that extends from the outer circumference of the tubular portion in the radial direction. The tubular portion is bent in an L-shape.

### PRIOR ART DOCUMENT

### Patent Document

Patent Document 1: JP 2014-138519 A

### SUMMARY OF THE INVENTION

### Problems to be Solved

With such a grommet, when electrical wire is inserted into the tubular portion, the electrical wire is pressed against the inner surface of the tubular portion bent in an L-shape, requiring the electrical wire to also be bent to conform with the bent shape of the same inner surface. This makes inserting the electrical wire through the grommet require time and effort.

An object of the present disclosure is to provide a grommet that allows electrical wire to be easily inserted through a tubular portion.

### Means to Solve the Problem

A grommet according to the present disclosure is configured to be attached to an attachment target extending in a virtual plane and includes: a tubular portion that extends in a first direction intersecting the virtual plane, an electrical wire being able to be inserted through the tubular portion; a collar portion located at an outer circumferential side of the tubular portion, the collar portion extending along the virtual plane; and a fold portion located between the tubular portion and the collar portion, the fold portion surrounding the tubular portion and projecting toward a distal end side of the tubular portion in the first direction, wherein the grommet is deformable between a first state in which the fold portion is contracted in a folded state and a second state in which at least a portion of the fold portion is extended, in the first state, an angle formed by an axis line of the tubular portion and the virtual plane corresponds to a first angle, in the second state, an angle formed by the axis line of the tubular portion and the virtual plane corresponds to a second angle smaller than the first angle, and a distal end opening of the tubular portion is orientated to a first side in a second direction aligned with the virtual plane, and a height of the fold portion in the first state increases from the first side in the second direction toward a second side opposite the first side.

### Effect of the Invention

According to the present disclosure, an electrical wire can be easily inserted through a tubular portion.

### BRIEF DESCRIPTION OF THE DRAWINGS

FIG. 1 is a cross-sectional view illustrating a grommet attached to a vehicle body panel via a bracket according to an embodiment.

FIG. 2 is an exploded perspective view of the grommet and the bracket of the same embodiment.

FIG. 3 is a plan view of the grommet.

FIG. 4 is a cross-sectional view taken along line 4-4 of FIG. 3.

FIG. 5 is a cross-sectional view corresponding to FIG. 4 illustrating how the grommet deforms from a first state to a second state.

### DETAILED DESCRIPTION TO EXECUTE THE INVENTION

### Description of Embodiments of the Present Disclosure

Firstly, embodiments of the present disclosure will be listed and described. A grommet according to the present disclosure (1) is configured to be attached to an attachment target extending in a virtual plane and includes: a tubular portion that extends in a first direction intersecting the virtual plane, an electrical wire being able to be inserted through the tubular portion; a collar portion located at an outer circumferential side of the tubular portion, the collar portion extending along the virtual plane; and a fold portion located between the tubular portion and the collar portion, the fold portion surrounding the tubular portion and projecting toward a distal end side of the tubular portion in the first direction, wherein the grommet is deformable between a first state in which the fold portion is contracted in a folded state and a second state in which at least a portion of the fold portion is extended, in the first state, an angle formed by an axis line of the tubular portion and the virtual plane corresponds to a first angle, in the second state, an angle formed by the axis line of the tubular portion and the virtual plane corresponds to a second angle smaller than the first angle, and a distal end opening of the tubular portion is orientated to a first side in a second direction aligned with the virtual plane, and a height of the fold portion in the first state increases from the first side in the second direction toward a second side opposite the first side.

According to this configuration, by just deforming the fold portion to extend at least a portion of the fold portion, the grommet can be deformed from the first state to the second state. After the electrical wire is inserted through the tubular portion of the grommet in the first state, the grommet can be deformed together with the electrical wire and put in the second state. This allows the electrical wire to be easily inserted through the tubular portion.
(2) Preferably, in the first state, an intermediate portion is provided between the tubular portion and the fold portion around an entire circumference of the tubular portion, and a length of the intermediate portion located on the first side of the tubular portion in the second direction is greater than a length of the intermediate portion located on both sides of the tubular portion in a third direction, where the third direction is a direction, aligned with the virtual plane, that is orthogonal to the second direction, and a length of the intermediate portion is a distance between the tubular portion and the fold portion in the intermediate portion.

According to this configuration, the intermediate portion is provided between the fold portion and the tubular portion. Also, the length of the intermediate portion located on the first side of the tubular portion in the second direction is greater than the length of the intermediate portion on both sides of the tubular portion in the third direction. Accordingly, when the grommet is deformed from the first state to the second state, a gap sufficient to allow for the deformation of the grommet is ensured between the fold portion and the tubular portion. This allows the fold portion to be easily deformed so that at least a portion of the fold portion is extended.

Also, the intermediate portions located on both sides of the tubular portion in the third direction can be made compact. This allows the grommet to be given a smaller size.
(3) Preferably, a length of the intermediate portion located on the second side of the tubular portion in the second direction is greater than a length of the intermediate portion located on both sides of the tubular portion in the third direction.

According to this configuration, the length of the intermediate portion located on the second side of the tubular portion in the second direction is greater than the length of the intermediate portion on both sides of the tubular portion in the third direction. Accordingly, when the grommet is deformed from the first state to the second state, a gap sufficient to allow for the deformation of the grommet is ensured between the fold portion and the tubular portion. This allows the fold portion to be easily deformed so that at least a portion of the fold portion is extended.

Also, the intermediate portions located on both sides of the tubular portion in the third direction can be made compact. This allows the grommet to be given a smaller size.
(4) Preferably, provided is an inner fold portion located between the tubular portion and an outer fold portion, the inner fold portion surrounding the tubular portion and projecting to a side opposite to the outer fold portion in the first direction, where the outer fold portion corresponds to the fold portion.

When the grommet is deformed from the first state to the second state, stress tends to concentrate at the portion between the tubular portion and the outer fold portion. Thus, a way of reinforcing this portion of the grommet is required.

Regarding this, according to the configuration described above, since the inner fold portion is provided between the tubular portion and the outer fold portion, when stress acts as described above, the stress is absorbed by the inner fold portion. Thus, the concentration of stress can be suppressed with a simple configuration.
(5) Preferably, provided is a second tubular portion that extends in a direction intersecting the virtual plane, an electrical wire being able to be inserted through the second tubular portion, wherein the second tubular portion is provided on an opposite side of the fold portion to a first tubular portion in a third direction, where the tubular portion is the first tubular portion, and the third direction is a direction, aligned with the virtual plane, that is orthogonal to the second direction.

According to this configuration, the grommet includes the plurality of tubular portions. Accordingly, a plurality of electrical wires can be inserted through the grommet.
(6) Preferably, the collar portion includes a circular external shape including a center, the first tubular portion is provided between the center and an outer edge of the collar portion, the fold portion includes an arc portion extending following the outer edge and a linear portion located on an opposite side of the first tubular portion to the arc portion and linearly extending in the second direction, and the second tubular portion is provided on an opposite side of the center to the first tubular portion.

According to this configuration, the first tubular portion and the second tubular portion can be compactly arranged in the grommet. This allows the fold portion and thus the grommet to be given a smaller size.
(7) Preferably, provided is a second fold portion located between the second tubular portion and the collar portion, the second fold portion surrounding the second tubular portion and projecting toward a distal end side of the second tubular portion in the first direction, where the fold portion corresponds to a first fold portion.

According to this configuration, by extending the second fold portion, the orientation direction of the distal end opening of the second tubular portion can be easily changed.
(8) Preferably, the grommet is configured to be attached to the attachment target via a bracket, and the collar portion includes an engagement portion for detachably attaching the bracket.

The bracket for attaching the grommet to the attachment target is molded to the grommet. According to this configuration, when the grommet deforms from the first state to the second state, the bracket tends to deform together with the grommet. Since the grommet surrounding the bracket deforms, the sealing properties of the grommet may be reduced.

Regarding this, according to the configuration described above, the bracket is detachably engaged with the engagement portion of the collar portion. This suppresses the deformation of the bracket when the grommet deforms. Accordingly, a decrease in the sealing properties of the grommet can be suppressed.

### Details of Embodiments of the Present Disclosure

Specific examples of the grommet according to the present disclosure will be described below with reference to the drawings. In the drawings, components of the configuration may be exaggerated or simplified for the sake of convenience. Also, the dimensions and proportions of the components may be different in each diagram. Note that the present disclosure is not limited to these examples and is defined by the scope of the claims, and all modifications that are equivalent to or within the scope of the claims are included. The term “orthogonal” used in the present specification does not mean only strictly orthogonal and also includes substantially orthogonal within a range in which the advantageous effects of the present embodiment can be achieved.

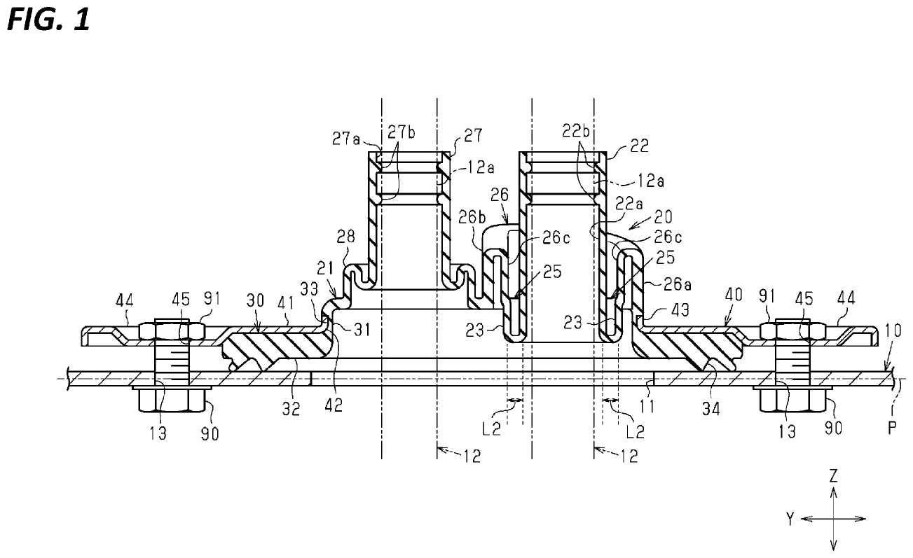

As illustrated in FIG. 1, a vehicle is provided with a vehicle body panel 10, which is the attachment target, that delineates the inside and outside of the vehicle. The vehicle body panel 10 is a panel that separates the space under the floor of the vehicle and the engine room and extends along a virtual plane P, for example.

The vehicle body panel 10 is provided with a through hole 11 that extends through the vehicle body panel 10.

An electrical wire 12 is inserted through the through hole 11. The electrical wire 12 is provided with a connector (not illustrated) at both end portions and, for example, electrically connects devices (not illustrated), such as an inverter and a motor, installed in the vehicle. In the present embodiment, two electrical wires 12 are inserted.

Also, at the portion of the vehicle body panel 10 forming the through hole 11, a grommet 20 is attached via a bracket 40.

Note that hereinafter, the direction orthogonal to the virtual plane P is defined as a first direction Z, the direction orthogonal to the first direction Z and aligned with the virtual plane P is defined as a second direction X, and the direction orthogonal to both the first direction Z and the second direction X and aligned with the virtual plane P is defined as a third direction Y.

<Grommet 20 Configuration>

As illustrated in FIG. 1, the grommet 20 is configured to waterproof the space between the electrical wires 12 and the portion of the vehicle body panel 10 forming the through hole 11.

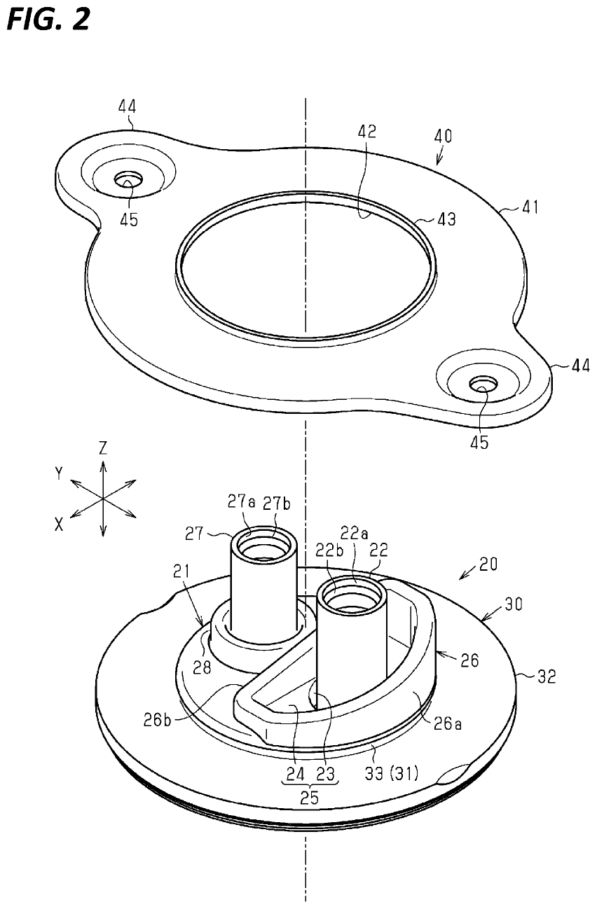

As illustrated in FIG. 2, the grommet 20 includes a base portion 21 that has a circular external shape and a collar portion 30 that extends radially outward from the outer circumferential edge of the base portion 21 and has a circular appearance. A center C of the base portion 21 and a center C of the collar portion 30 are coaxially located aligned with the first direction Z.

The base portion 21 includes a first tubular portion 22, an intermediate portion 25, and a first fold portion 26.

Also, the base portion 21 includes a second tubular portion 27 and a second fold portion 28.

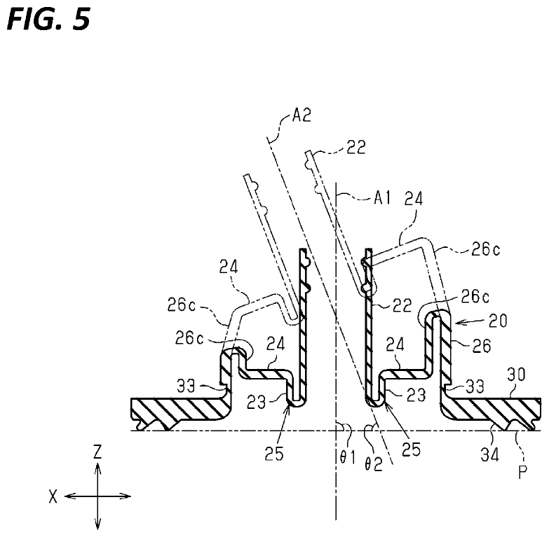

The grommet 20 can deform between a first state in which the first fold portion 26 is contracted in a folded state and a second state (see FIG. 5) in which a portion of the first fold portion 26 is extended. Firstly, the grommet 20 in the first state will be described in detail below.

As illustrated in FIG. 1, the first tubular portion 22 extends in the first direction Z, and the electrical wire 12 can be inserted through the first tubular portion 22.

As illustrated in FIG. 4, in the first state, a first angle θ1 formed by an axis line A1 of the first tubular portion 22 and the virtual plane P is a right angle.

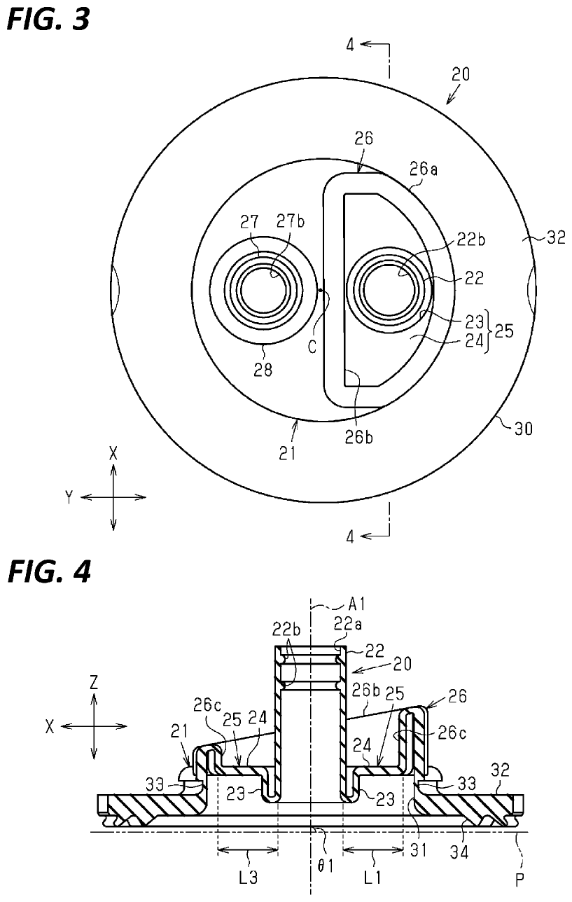

As illustrated in FIG. 3, the first tubular portion 22 is provided between the center C and the outer edge of the collar portion 30. Specifically, the first tubular portion 22 is provided between the center C and the outer edge of the base portion 21.

As illustrated in FIGS. 1 and 2, the first tubular portion 22 includes an annular projection portion 22b that projects from an inner circumferential surface 22a. The projection portion 22b is provided on the distal end side of the first tubular portion 22 in the first direction Z. The projection portion 22b is in contact with and pressed against an outer circumferential surface 12a of the electrical wire 12, sealing the space between the electrical wire 12 and the first tubular portion 22.

As illustrated in FIGS. 1, 3, and 4, the intermediate portion 25 includes an inner fold portion 23 and a planar portion 24 that extends along the virtual plane P.

The inner fold portion 23 extends in the first direction Z and projects in the first direction Z to the side opposite the distal end side of the first tubular portion 22. The inner fold portion 23 surrounds the entire circumference of the first tubular portion 22 (see FIG. 3). The inner circumferential portion of the inner fold portion 23 is formed of the base end of the first tubular portion 22. Of the end portions on the outer circumferential side of the inner fold portion 23, the end portions located on both sides of the first tubular portion 22 in the second direction X are connected to the planar portion 24 (see FIG. 4). Also, of the end portions on the outer circumferential side of the inner fold portion 23, the end portions located on both sides of the first tubular portion 22 in the third direction Y are connected to the first fold portion 26 (see FIG. 1).

As illustrated in FIG. 4, the planar portion 24 extends from the end portion on the outer circumference side of the inner fold portion 23 radially outward along the virtual plane P and is connected to the first fold portion 26.

In other words, the intermediate portion 25 is located between the first tubular portion 22 and the first fold portion 26 and is provided around the entire circumference of the first tubular portion 22.

Herein, the distance of the intermediate portion 25 between the first tubular portion 22 to the first fold portion 26 is defined as the length of the intermediate portion 25.

As illustrated in FIGS. 1 and 4, a length L3 of the intermediate portion 25 on a first side (left side in FIG. 4) of the first tubular portion 22 in the second direction X is greater than a length L2 of the intermediate portion 25 at both sides of the first tubular portion 22 in the third direction Y (L3>L2).

Also, a length L1 of the intermediate portion 25 on a second side (right side in FIG. 4) of the first tubular portion 22 in the second direction X is greater than the length L2 of the intermediate portion 25 at both sides of the first tubular portion 22 in the third direction Y (L1>L2). Note that in the present embodiment, L1=L3.

The first fold portion 26 projects toward the distal end side of the first tubular portion 22 in the first direction Z.

As illustrated in FIG. 3, the first fold portion 26 surrounds the entire circumference of the first tubular portion 22. Note that the first fold portion 26 corresponds to the outer fold portion in the “Detailed Description to Execute the Invention”.

As illustrated in FIG. 4, the projection height of the first fold portion 26 from the base portion 21, in the first state, for example, continuously increases from the first side (left side in FIG. 4) in the second direction X toward the second side (right side in FIG. 4) opposite the first side.

As illustrated in FIG. 3, the first fold portion 26 includes an arc portion 26a and a linear portion 26b.

The arc portion 26a extends following the outer edge of the base portion 21.

The linear portion 26b linearly extends in the second direction X and is located on the opposite side of the first tubular portion 22 to the arc portion 26a.

As illustrated in FIGS. 1 and 4, the first fold portion 26 is contracted in a folded state in the first state. In other words, the first fold portion 26 includes an opposing wall 26c that opposes the outer circumferential surface of the first tubular portion 22 in the first state.

As illustrated in FIG. 1, the second tubular portion 27 extends in the first direction Z orthogonal to the virtual plane P, and the electrical wire 12 can be inserted through the second tubular portion 27.

As illustrated in FIG. 3, the second tubular portion 27 is provided on the opposite side of the linear portion 26b of the first fold portion 26 to the first tubular portion 22 in the third direction Y. The second tubular portion 27 is provided on the opposite side of the center C of the base portion 21 to the first tubular portion 22.

As illustrated in FIG. 1, the second tubular portion 27 includes an annular projection portion 27b that projects from an inner circumferential surface 27a. The projection portion 27b is provided on the distal end side of the second tubular portion 27 in the first direction Z. The projection portion 27b is in contact with and pressed against an outer circumferential surface 12a of the electrical wire 12, waterproofing the space between the electrical wire 12 and the second tubular portion 27.

The second fold portion 28 projects toward the distal end side of the second tubular portion 27 in the first direction Z. The second fold portion 28 surrounds the entire circumference of the second tubular portion 27 (see FIG. 3). The inner circumferential end portion of the second fold portion 28 is connected to the base end of the second tubular portion 27. The outer circumferential end portion of the second fold portion 28 is connected to the base portion 21. In other words, the second fold portion 28 is located between the second tubular portion 27 and the collar portion 30.

As illustrated in FIGS. 1 and 2, the projection height of the second fold portion 28 from the base portion 21 is constant all around in the circumferential direction.

As illustrated in FIGS. 2 and 3, the collar portion 30 includes a connection portion 31 that extends from the outer circumferential edge of the base portion 21 to the opposite side to the distal end side of the first tubular portion 22 in the first direction Z and a body portion 32 that bends radially outward from the connection portion 31 and extends along the virtual plane P.

As illustrated in FIGS. 1 and 4, the connection portion 31 includes an engagement portion 33 for detachably attaching the bracket 40. The engagement portion 33 is provided around the entire circumference of the outer circumferential surface of the connection portion 31. The engagement portion 33 is a radially-outward-opening recess portion.

A seal projection portion 34 projects out from the surface of the body portion 32 that opposes the vehicle body panel 10. The seal projection portion 34 is provided around the entire circumference of the body portion 32. The seal projection portion 34 is in contact with and pressed against the vehicle body panel 10, sealing the space between the same portion and the grommet 20.

Next, the grommet 20 in the second state will be described.

As indicated by the two-dot dash line in FIG. 5, a portion including the opposing wall 26c of the first fold portion 26 is extended toward the distal end side of the first tubular portion 22 in the first direction Z.

The distal end opening of the first tubular portion 22 is orientated to the first side (left side in FIG. 5) in the second direction X.

A second angle θ2 formed by an axis line A2 of the first tubular portion 22 and the virtual plane P is smaller than the first angle θ1.

The grommet 20 is formed by integrally forming together the first tubular portion 22, the intermediate portion 25, the first fold portion 26, the second tubular portion 27, the second fold portion 28, and the collar portion 30. A rubber, elastomer, or other elastic material may be used as the material of the grommet 20, for example.

<Bracket 40 Configuration>

As illustrated in FIGS. 1 and 2, the bracket 40 includes a body portion 41 opposing the body portion 32 of the collar portion 30 in the first direction Z and two fixing portions 44.

The body portion 41 includes an insertion hole 42 through which the base portion 21 is inserted and a projection portion 43 that rises up from the edge portion forming the insertion hole 42.

As illustrated in FIG. 2, the projection portion 43 is provided around the entire circumference of the edge portion. The bracket 40 is detachably attached to the grommet 20 via engagement of the projection portion 43 with the engagement portion 33 of the collar portion 30.

The two fixing portions 44 project radially outward from the outer circumferential edge of the body portion 41.

As illustrated in FIG. 1, the fixing portions 44 each include a fastening hole 45 where a screw 90 for fixing to the vehicle body panel 10 is inserted. By inserting the screw 90 inserted through a hole 13 of the vehicle body panel 10 through the fastening hole 45 and screwing on a nut 91, the grommet 20 and the bracket 40 are attached to the vehicle body panel 10.

Next, the advantages of the present embodiment will be described.

By just deforming the first fold portion 26 to extend a portion of the first fold portion 26, the grommet 20 can be deformed from the first state to the second state. At this time, the first tubular portion 22 is held, by the first fold portion 26, in a state in which the angle formed by the axis line A2 of the first tubular portion 22 and the virtual plane P corresponds to the second angle θ2, which is larger than the first angle θ1.

Next, the effects of the present embodiment will be described.
(1) The grommet 20 can deform between the first state in which the first fold portion 26 is contracted in a folded state and the second state in which at least a portion of the first fold portion 26 is extended. In the first state, the angle formed by the axis line A1 of the first tubular portion 22 and the virtual plane P corresponds to the first angle θ1. In the second state, the angle formed by the axis line A2 of the first tubular portion 22 and the virtual plane P corresponds to the second angle θ2, which is smaller than first angle θ1. The distal end opening of the first tubular portion 22 is orientated to the first side in the second direction X aligned with the virtual plane P. The height of the first fold portion 26 in the first state increases from the first side in the second direction X toward the second side opposite the first side.

According to this configuration, the following effects are realized. After the electrical wire 12 is inserted through the first tubular portion 22 of the grommet 20 in the first state, the grommet 20 can be deformed together with the electrical wire 12 and put in the second state. This allows the electrical wire 12 to be easily inserted through the first tubular portion 22.
(2) In the first state, the intermediate portion 25 is provided between the first tubular portion 22 and the first fold portion 26 around the entire circumference of the first tubular portion 22. The length L3 of the intermediate portion 25 located on the first side of the first tubular portion 22 in the second direction X is greater than the length L2 of the intermediate portion 25 on both sides of the first tubular portion 22 in the third direction Y.

According to this configuration, the intermediate portion 25 is provided between the first fold portion 26 and the first tubular portion 22. Also, the length L3 of the intermediate portion 25 located on the first side of the first tubular portion 22 in the second direction X is greater than the length L2 of the intermediate portion on both sides of the first tubular portion 22 in the third direction Y. Accordingly, when the grommet 20 is deformed from the first state to the second state, a gap sufficient to allow for the deformation of the grommet 20 is ensured between the first fold portion 26 and the first tubular portion 22. This allows the first fold portion 26 to be easily deformed so that at least a portion of the first fold portion 26 is extended.

Also, the intermediate portions 25 located on both sides of the first tubular portion 22 in the third direction Y can be made compact. This allows the grommet 20 to be given a smaller size.
(3) The length L1 of the intermediate portion 25 located on the second side of the first tubular portion 22 in the second direction X is greater than the length L2 of the intermediate portion 25 on both sides of the first tubular portion 22 in the third direction Y.

According to such a configuration, the length L1 of the intermediate portion 25 located on the second side of the first tubular portion 22 in the second direction X is greater than the length L2 of the intermediate portion 25 on both sides of the first tubular portion 22 in the third direction Y. Accordingly, when the grommet 20 is deformed from the first state to the second state, a gap sufficient to allow for the deformation of the grommet 20 is ensured between the first fold portion 26 and the first tubular portion 22. This allows the first fold portion 26 to be easily deformed so that at least a portion of the first fold portion 26 is extended.

Also, the intermediate portions 25 located on both sides of the first tubular portion 22 in the third direction Y can be made compact. This allows the grommet 20 to be given a smaller size.
(4) The inner fold portion 23 is provided between the first tubular portion 22 and the first fold portion 26 and surrounds the first tubular portion 22, projecting to the opposite side of the first fold portion 26 in the first direction Z.

When the grommet 20 is deformed from the first state to the second state, stress tends to concentrate at the portion between the first tubular portion 22 and the first fold portion 26. Thus, a way of reinforcing this portion of the grommet 20 is required.

Regarding this, according to the configuration described above, since the inner fold portion 23 is provided between the first tubular portion 22 and the first fold portion 26, when stress acts as described above, the stress is absorbed by the inner fold portion 23. Thus, the concentration of stress can be suppressed with a simple configuration.
(5) The second tubular portion 27 is provided extending in a direction that intersects the virtual plane P, and the electrical wire 12 can be inserted through the second tubular portion 27. The second tubular portion 27 is provided on the opposite side of the first fold portion 26 to the first tubular portion 22 in the third direction Y.

According to this configuration, the grommet 20 includes the plurality of tubular portions 22 and 27. Accordingly, the plurality of electrical wires 12 can be inserted through the grommet 20.
(6) The collar portion 30 has a circular external shape that includes the center C. The first tubular portion 22 is provided between the center C and the outer edge of the collar portion 30. The first fold portion 26 includes the arc portion 26a extending following the outer edge described above and the linear portion 26b located on the opposite side of the first tubular portion 22 to the arc portion 26a and linearly extending in the second direction X. The second tubular portion 27 is provided on the opposite side of the center C to the first tubular portion 22.

According to this configuration, the first tubular portion 22 and the second tubular portion 27 can be compactly arranged in the grommet 20. This allows the first fold portion 26 and thus the grommet 20 to be given a smaller size.
(7) The second fold portion 28 is provided between the second tubular portion 27 and the collar portion 30 and surrounds the second tubular portion 27, projecting toward the distal end side of the second tubular portion 27 in the first direction Z.

According to this configuration, by extending the second fold portion 28, the orientation direction of the distal end opening of the second tubular portion 27 can be easily changed.
(8) The grommet 20 is attached to the vehicle body panel 10 via the bracket 40. The collar portion 30 includes the engagement portion 33 for detachably attaching the bracket 40.

The bracket 40 for attaching the grommet 20 to the vehicle body panel 10 is molded to the grommet 20. According to this configuration, when the grommet 20 deforms from the first state to the second state, the bracket 40 tends to deform together with the grommet 20. Since the grommet 20 surrounding the bracket 40 deforms, the sealing properties of the grommet 20 may be reduced.

Regarding this, according to the configuration described above, the bracket 40 is detachably engaged with the engagement portion 33 of the collar portion 30. This suppresses the deformation of the bracket 40 when the grommet 20 deforms. Accordingly, a decrease in the sealing properties of the grommet 20 can be suppressed.

### Modified Example

The following modifications can be made to the present embodiment. The present embodiment and the following modified examples can be implemented in any combination within the bounds of technical consistency.
The engagement portion 33 is not limited to being a radially-outward-opening recess portion as described in the present embodiment, and the shape can be changed as appropriate for the installation requirements of the bracket 40. For example, the engagement portion 33 may be a recess portion opening to the distal end side of the first tubular portion 22 in the first direction Z. In this case, the projection portion 43 of the bracket 40 extends from the edge portion forming the insertion hole 42 to the side opposite the distal end side.
The collar portion 30 is not limited to including the engagement portion 33, and the engagement portion 33 may be omitted, for example. In this case, the bracket 40 may be molded to the grommet 20.
The shape of the second fold portion 28 is not limited to the shape described in the present embodiment. For example, the second fold portion 28 may increase in size from the first side (left side in FIG. 4) in the second direction X toward the second side (right side in FIG. 4) opposite the first side.
The second fold portion 28 may increase in size from the second side (right side in FIG. 4) in the second direction X toward the first side (left side in FIG. 4) opposite the second side. In other words, the second fold portion 28 may be inclined to the opposite side to the first fold portion 26.

Consider an example in which the grommet 20 is formed with the first tubular portion 22 and the second tubular portion 27 bent in advance to conform to the routing paths of the two electrical wires 12 that intersect. In this example, one of the tubular portions 22 and 27 is undercut, making the grommet 20 difficult to form.

Regarding this, according to the configuration described above, the two electrical wires 12 can be allowed to intersect by deforming the first tubular portion 22 and the second tubular portion 27 after the electrical wires 12 are inserted through the first tubular portion 22 and the second tubular portion 27 of the grommet 20 in the first state. Accordingly, even when the routing paths of the two electrical wire 12 intersect, the grommet 20 can be easily formed.
The position of second tubular portion 27 is not limited to being on the opposite side of the center C to the first tubular portion 22 as described in the present embodiment and may be changed as appropriate. As long as the second tubular portion 27 is provided on the opposite side of the first fold portion 26 to the first tubular portion 22 in the third direction Y, the second tubular portion 27 may be provided on the center C, for example.
The second tubular portion 27 and the second fold portion 28 may be omitted.
The collar portion 30 is not limited to have a circular external shape as described in the present embodiment, and the shape may be changed as appropriate. For example, the collar portion 30 may have an oval external shape, an oblong external shape, or an elliptical external shape.
The first fold portion 26 is not limited to including the arc portion 26a and the linear portion 26b and may be formed of only a linear fold portion or formed of only an arc-shaped fold portion, for example.
The length of the intermediate portion 25 is not limited to the length described in the present embodiment and can be changed as appropriate. For example, L2 may be made the same size as L1 and L3. In this case, the planar portion 24 is provided between, of the end portions on the outer circumferential side of the inner fold portion 23, the end portions located on both sides of the first tubular portion 22 in the third direction Y and the first fold portion 26.
The intermediate portion 25 is not limited to including the inner fold portion 23 and the planar portion 24, and either the inner fold portion 23 or the planar portion 24 may be omitted, for example.
The first fold portion 26 is not limited to surrounding the first tubular portion 22 all around in the circumferential direction as described in the present embodiment. For example, the first fold portion 26 located on the first side (left side in FIG. 4) of the first tubular portion 22 in the second direction X may be omitted. In this case, the first fold portion 26 is only required to rise from the base portion 21 and increase in projection height from the base portion 21 toward the second side (right side in FIG. 4) opposite the first side.
With the grommet 20 in the first state, the first angle θ1 is not limited to being a right angle. In other words, with the grommet 20, the first angle θ1 may be smaller than a right angle.
The grommet 20 may be a single piece of elastic material, for example.
The first fold portion 26 may be configured to reversibly elastically deform between the first state and the second state. The first fold portion 26 can transition from the first state to the second state via a first predetermined intermediate transition state between the first state and the second state and can transition from the second state to the first state via a second predetermined intermediate transition state. The first predetermined intermediate transition state and the second predetermined intermediate transition state are typically different but may be the same. For example, when the application of an external force to deform the first fold portion 26 is suspended at the point in time when the first fold portion 26 has deformed from the first state to the first predetermined intermediate transition state, the first fold portion 26 can automatically transition to the second state without any further application of an external force, for example. When the application of an external force to deform the first fold portion 26 is suspended before the point in time when the first fold portion 26 has deformed from the first state to the first predetermined intermediate transition state, the first fold portion 26 can automatically return to the first state without any further application of an external force, for example. Also, when the application of an external force to deform the first fold portion 26 is suspended at the point in time when the first fold portion 26 has deformed from the second state to the second predetermined intermediate transition state, the first fold portion 26 can automatically transition to the first state without any further application of an external force, for example. When the application of an external force to deform the first fold portion 26 is suspended before the point in time when the first fold portion 26 has deformed from the second state to the second predetermined intermediate transition state, the first fold portion 26 can automatically return to the second state without any further application of an external force, for example.
In the embodiments described above, the first fold portion 26 and the second fold portion 28 may deform independent of one another. For example, when the first fold portion 26 elastically deforms between the first state and the second state, the second fold portion 28 may not deform. For example, regardless of the elastically deformation of the second fold portion 28, the first fold portion 26 may elastically deform between the first state and the second state. For example, regardless of the elastically deformation of the second fold portion 28, the first fold portion 26 may be held in the first state or the second state.
In the embodiments described above, the collar portion 30 of the grommet 20 may be referred as a base end side of the grommet 20. The first tubular portion 22 may include a distal end opening and a base end opening. The first tubular portion 22 may be referred to as a waterproof sleeve configured to come into contact with the outer circumferential surface of the electrical wire 12 in a waterproof manner.
The first angle θ1 may be referred to as a first orientation angle of the distal end opening of the first tubular portion 22. The second angle θ2 may be referred to as a second orientation angle of the distal end opening of the first tubular portion 22.
The first state of the embodiments described above may be referred to as a contracted state of the first fold portion 26, a first angle state of the first tubular portion 22, or a first height state of the first tubular portion 22. The second state of the embodiments described above may be referred to as an extended state of the first fold portion 26, a second angle state of the first tubular portion 22, or a second height state of the first tubular portion 22.
When the grommet 20 is in the first state, the distal end opening of the first tubular portion 22 is at a first height position based on the collar portion 30 and can have the first orientation angle (θ1) based on the collar portion 30. When the grommet 20 is in the second state, the distal end opening of the first tubular portion 22 is at a second height position different from the first height position based on the collar portion 30 and can have a second orientation angle (02) different from the first orientation angle (θ1) based on the collar portion 30.
For example, the grommet (20) according to an aspect of the present disclosure is a single component including:
a collar portion (30) configured to attached to an attachment surface (P);
a waterproof sleeve (22) configured to come into contact with an outer circumferential surface of an electrical wire (12) in a waterproof manner and including a distal end opening, a base end opening, and sleeve axis lines (A1 and A2); and
an elastic fold portion (26) that elastically connects the collar portion (30) and the waterproof sleeve (22), wherein
the elastic fold portion (26) is configured in an elastically deforming manner so that
the waterproof sleeve (22) maintains the first state in which the distal end opening of the waterproof sleeve (22) is at a first height position based on the collar portion (30) and the distal end opening of the waterproof sleeve (22) includes the first orientation angle (θ1) based on the collar portion (30),
the waterproof sleeve (22) maintains the second state in which the distal end opening of the waterproof sleeve (22) is at a second height position different from the first height position based on the collar portion (30) and the distal end opening of the waterproof sleeve (22) includes the second orientation angle (02) different from the first orientation angle (θ1) based on the collar portion (30),
the waterproof sleeve (22) reversible transitions between the first state and the second state,
the waterproof sleeve (22) automatically transitions to the first state from the first predetermined intermediate transition state between the first state and the second state, and
the waterproof sleeve (22) automatically transitions to the second from the second predetermined intermediate transition state between the first state and the second state.

### LIST OF REFERENCE NUMERALS

P Virtual plane
Z First direction
X Second direction
Y Third direction
C Center
A1 Axis line
A2 Axis line
θ1 First angle
θ2 Second angle
L1 Length
L2 Length
L3 Length
10 Vehicle body panel (attachment target)
11 Through hole
12 Electrical wire
12a Outer circumferential surface
13 Hole
20 Grommet
21 Base portion
22 First tubular portion
22a Inner circumferential surface
22b Projection portion
23 Inner fold portion
24 Planar portion
25 Intermediate portion
26 First fold portion
26a Arc portion
26b Linear portion
26c Opposing wall
27 Second tubular portion
27a Inner circumferential surface
27b Projection portion
28 Second fold portion
30 Collar portion
31 Connection portion
32 Body portion
33 Engagement portion
34 Seal projection portion
40 Bracket
41 Body portion
42 Insertion hole
43 Projection portion
44 Fixing portion
45 Fastening hole
90 Screw
91 Nut

1. A grommet configured to be attached to an attachment target extending in a virtual plane, comprising:
a tubular portion that extends in a first direction intersecting the virtual plane, an electrical wire being able to be inserted through the tubular portion;
a collar portion located at an outer circumferential side of the tubular portion, the collar portion extending along the virtual plane; and
a fold portion located between the tubular portion and the collar portion, the fold portion surrounding the tubular portion and projecting toward a distal end side of the tubular portion in the first direction,
wherein the grommet is deformable between a first state in which the fold portion is contracted in a folded state and a second state in which at least a portion of the fold portion is extended,
in the first state, an angle formed by an axis line of the tubular portion and the virtual plane corresponds to a first angle,
in the second state, an angle formed by the axis line of the tubular portion and the virtual plane corresponds to a second angle smaller than the first angle, and a distal end opening of the tubular portion is orientated to a first side in a second direction aligned with the virtual plane, and
a height of the fold portion in the first state increases from the first side in the second direction toward a second side opposite the first side.

2. The grommet according to claim 1, wherein
in the first state, an intermediate portion is provided between the tubular portion and the fold portion around an entire circumference of the tubular portion, and
a length of the intermediate portion located on the first side of the tubular portion in the second direction is greater than a length of the intermediate portion located on both sides of the tubular portion in a third direction, where the third direction is a direction, aligned with the virtual plane, that is orthogonal to the second direction, and a length of the intermediate portion is a distance between the tubular portion and the fold portion in the intermediate portion.

3. The grommet according to claim 2, wherein
a length of the intermediate portion located on the second side of the tubular portion in the second direction is greater than a length of the intermediate portion located on both sides of the tubular portion in the third direction.

4. The grommet according to claim 1, further comprising:
an inner fold portion located between the tubular portion and an outer fold portion, the inner fold portion surrounding the tubular portion and projecting to a side opposite to the outer fold portion in the first direction, where the outer fold portion corresponds to the fold portion.

5. The grommet according to claim 1, further comprising:
a second tubular portion that extends in a direction intersecting the virtual plane, an electrical wire being able to be inserted through the second tubular portion,
wherein the second tubular portion is provided on an opposite side of the fold portion to a first tubular portion in a third direction, where the tubular portion is the first tubular portion, and the third direction is a direction, aligned with the virtual plane, that is orthogonal to the second direction.

6. The grommet according to claim 5, wherein
the collar portion includes a circular external shape including a center,
the first tubular portion is provided between the center and an outer edge of the collar portion,
the fold portion includes an arc portion extending following the outer edge and a linear portion located on an opposite side of the first tubular portion to the arc portion and linearly extending in the second direction, and
the second tubular portion is provided on an opposite side of the center to the first tubular portion.

7. The grommet according to claim 5, further comprising:
a second fold portion located between the second tubular portion and the collar portion, the second fold portion surrounding the second tubular portion and projecting toward a distal end side of the second tubular portion in the first direction, where the fold portion corresponds to a first fold portion.

8. The grommet according to claim 1, wherein
the grommet is configured to be attached to the attachment target via a bracket, and
the collar portion includes an engagement portion for detachably attaching the bracket.
